(19) United States
(12) Patent Application Publication
(10) Pub. No.: US 2015/0096492 A1
(43) Pub. Date: Apr. 9, 2015

(54) COATING APPARATUS

(71) Applicant: Tokyo Electron Limited, Tokyo (JP)

(72) Inventor: Takayuki ISHII, Kikuchi-gun (JP)

(21) Appl. No.: 14/481,998

(22) Filed: Sep. 10, 2014

(30) Foreign Application Priority Data
Oct. 3, 2013 (JP) 2013-208526
May 26, 2014 (JP) 2014-108493

(51) Int. Cl. B05B 12/02; B05B 3/18; B05B 1/04

(52) U.S. Cl. CPC B05B 12/02; B05B 1/044; B05B 3/18
USPC 118/323

(57) ABSTRACT

A coating apparatus includes: a slit nozzle that discharges a coating material from a discharge port in a slit shape; a moving mechanism that relatively moves the slit nozzle with respect to a substrate in a disk shape; and a control unit that controls the moving mechanism, wherein the control unit performs a first constant speed coating treatment of relatively moving the slit nozzle with respect to the substrate at a first speed, then an acceleration coating treatment of accelerating a relative moving speed of the slit nozzle with respect to the substrate to a second speed higher than the first speed, and then a second constant speed coating treatment of relatively moving the slit nozzle with respect to the substrate at the second speed.

### CROSS REFERENCE TO RELATED APPLICATIONS

This application is based upon and claims the benefit of priority of the prior Japanese Patent Application No. 2013-208526, filed in Japan on Oct. 3, 2013, and the prior Japanese Patent Application No. 2014-108493, filed in Japan on May 26, 2014, the entire contents of which are incorporated herein by reference.

### BACKGROUND OF THE INVENTION

1. Field of the Invention

The present invention relates to a coating apparatus.

2. Description of the Related Art

As one technique of applying a coating material to a substrate such as a semiconductor wafer, a glass substrate or the like, a slit coating method is known. The slit coating method is a technique of applying the coating material onto the substrate by scanning a slit nozzle having a discharge port in a slit shape (refer to Japanese Laid-open Patent Publication No. 2011-167603).

In the above-described slit coating method, it is conceivable to shorten the time required for a coating treatment by increasing the moving speed of the slit nozzle.

However, if the moving speed is simply increased, for example, a diffusion speed of the coating material in the width direction of the slit nozzle does not follow any longer the moving speed of the slit nozzle and may cause uncoated areas on both right and left sides of the substrate. Further, if the moving speed of the slit nozzle is too high, the coating material may break to cause steak-like uncoated areas along the moving direction of the slit nozzle.

As described above, in the prior art, if the moving speed of the slit nozzle is simply increased, the uncoated areas may occur on the substrate to impair film thickness uniformity.

### SUMMARY OF THE INVENTION

An object of the present invention is to shorten the time required for a coating treatment while securing film thickness uniformity.

The present invention is a coating apparatus for applying a coating material to a substrate, including: a slit nozzle that has a discharge port in a slit shape and discharges the coating material from the discharge port; a moving mechanism that relatively moves the slit nozzle with respect to a substrate in a disk shape; and a control unit that controls the moving mechanism. Further, the control unit is configured to control the moving mechanism to thereby perform a first constant speed coating treatment of relatively moving the slit nozzle with respect to the substrate at a first speed, an acceleration coating treatment of accelerating, after the first constant speed coating treatment, a relative moving speed of the slit nozzle with respect to the substrate to a second speed higher than the first speed, and a second constant speed coating treatment of relatively moving, after the acceleration coating treatment, the slit nozzle with respect to the substrate at the second speed.

According to the present invention, it is possible to shorten the time required for a coating treatment while ensuring film thickness uniformity.

### BRIEF DESCRIPTION OF THE DRAWINGS

FIG. 1 is a schematic side view illustrating a configuration of a coating apparatus according to this embodiment.

FIG. 2 is a schematic explanatory view of a coating treatment.

FIG. 3 is a schematic view illustrating a configuration of a slit nozzle.

FIG. 4A is a view for explaining an example of a situation in which uncoated areas are formed on a substrate.

FIG. 4B is a view for explaining the example of the situation in which the uncoated areas are formed on the substrate.

FIG. 5 is a view for explaining another example of a situation in which uncoated areas are formed on the substrate.

FIG. 6 is a view for explaining treatment sections of a first constant speed coating treatment, an acceleration coating treatment, and a second constant speed coating treatment.

FIG. 7A is a chart for explaining an example of the coating treatment according to this embodiment.

FIG. 7B is a chart for explaining an example of the coating treatment according to this embodiment.

FIG. 7C is a chart for explaining an example of the coating treatment according to this embodiment.

FIG. 7D is a chart for explaining an example of the coating treatment according to this embodiment.

FIG. 8 is a chart illustrating an evaluation result of the coating apparatus according to this embodiment.

FIG. 9A is a chart for explaining an example of the coating treatment according to a modification example of this embodiment.

FIG. 9B is a chart for explaining an example of the coating treatment according to a modification example of this embodiment.

### DETAILED DESCRIPTION OF THE INVENTION

Hereinafter, an embodiment of a coating apparatus disclosed by this application will be described in detail referring to the accompanying drawings. Note that the present invention is not limited to the embodiment described below.

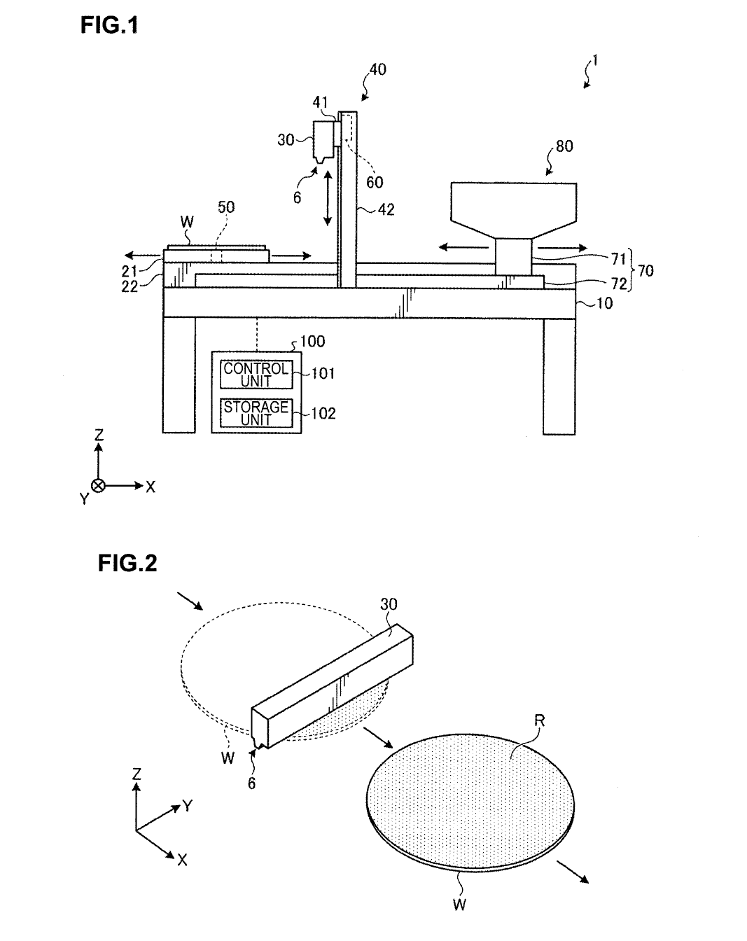

FIG. 1 is a schematic view illustrating a configuration of a coating apparatus according to this embodiment. Note that for clarifying the positional relationship, an X-axis, a Y-axis, and a Z-axis are defined and a Z-axis positive direction is assumed to be a vertical upward direction.

As illustrated in FIG. 1, a coating apparatus 1 according to this embodiment includes a mounting table 10, a stage 21, a first moving mechanism 22, a slit nozzle 30, and a raising and lowering mechanism 40.

On the stage 21, a substrate W is mounted. Concretely, the stage 21 has a horizontal upper surface formed with a suction port and horizontally holds the substrate W by attracting the substrate W thereto by suction through the suction port. The stage 21 is disposed at the top of the first moving mechanism 22.

The first moving mechanism 22 is mounted on the mounting table 10 and moves the stage 21 in the horizontal direction (here, an X-axis direction). Thus, the substrate W horizontally held on the stage 21 is horizontally moved.

The slit nozzle 30 is a long nozzle and disposed above the substrate W held on the stage 21. The slit nozzle 30 is attached to the later-described raising and lowering mechanism 40 with its longitudinal direction directed to the horizontal direction (Y-axis direction) perpendicular to the moving direction (X-axis direction) of the stage 21.

The slit nozzle 30 discharges a high-viscosity coating material such as a resist, a sealant, or an adhesive from a discharge port 6 in a slit shape formed at its lower portion. The configuration of the slit nozzle 30 will be described later.

The raising and lowering mechanism 40 is a mechanism unit that raises and lowers the slit nozzle 30 in the vertical direction (Z-axis direction), and mounted on the mounting table 10. The raising and lowering mechanism 40 includes a fixing unit 41 to which the slit nozzle 30 is fixed, and a drive unit 42 that moves the fixing unit 41 in the vertical direction (Z-axis direction).

The coating apparatus 1 includes a nozzle height measurement unit 50, a thickness measurement unit 60, a second moving mechanism 70, a nozzle waiting unit 80, and a control apparatus 100.

The nozzle height measurement unit 50 is a measurement unit that measures the distance from a predetermined measurement position to the lower surface of the slit nozzle 30. The nozzle height measurement unit 50 is embedded, for example, in the stage 21.

The thickness measurement unit 60 is a measurement unit that is disposed above the substrate W on the state 21 and measures the distance to the upper surface of the substrate W. The thickness measurement unit 60 is attached, for example, to the raising and lowering mechanism 40. Note that the coating apparatus 1 uses the thickness measurement unit 60 to perform processing of measuring the distance from the measurement position of the thickness measurement unit 60 to the upper surface of the stage 21, and the distance from the measurement position of the thickness measurement unit 60 to the upper surface of the substrate W mounted on the stage 21.

Measurement results by the nozzle height measurement unit 50 and the thickness measurement unit 60 are sent to the later-described control apparatus 100 and used for deciding the height of the slit nozzle 30, for example, at the coating treatment.

The second moving mechanism 70 moves the nozzle waiting unit 80 in the horizontal direction. The second moving mechanism 70 includes a support unit 71 and a drive unit 72. The support unit 71 horizontally supports the nozzle waiting unit 80. The drive unit 72 is mounted on the mounting table 10 and moves the support unit 71 in the horizontal direction.

The nozzle waiting unit 80 is a place where the slit nozzle 30 finished a coating operation waits until the next coating operation is started. In the nozzle waiting unit 80, replenishing processing of replenishing the slit nozzle 30 with the coating material, and priming processing of priming the state of the discharge port by wiping away the coating material adhering to the discharge port of the slit nozzle 30.

The control apparatus 100 is an apparatus that controls the operation of the coating apparatus 1. The control apparatus 100 is, for example, a computer and includes a control unit 101 and a storage unit 102. The storage unit 102 stores a program that controls various processing and treatments such as the coating treatment. The control unit 101 controls the operation of the coating apparatus 1 by reading and executing the program stored in the storage unit 102.

Note that the program may be the one that is stored, for example, in a computer-readable recording medium and installed from the recording medium to the storage unit 102 of the control apparatus 100. Examples of the computer-readable recording medium include a hard disk (HD), a flexible disk (FD), a compact disk (CD), a magneto-optical disk (MO), and a memory card.

Next, the outline of the coating treatment performed by the coating apparatus 1 will be described using FIG. 2. FIG. 2 is a schematic explanatory view of the coating treatment.

As illustrated in FIG. 2, first, the coating apparatus 1 slightly exposes a coating material R from the discharge port 6 in a slit shape formed in the slit nozzle 30 and forms a bead (solution droplet) of the coating material R at the discharge port. The coating apparatus 1 then lowers the slit nozzle 30 using the raising and lowering mechanism 40 (see FIG. 1) and brings the bead of the coating material R formed at the discharge port 6 into contact with the upper surface of the substrate W.

The coating apparatus 1 then horizontally moves the substrate W mounted on the stage 21 using the first moving mechanism 22 (see FIG. 1) in the direction (here, the X-axis positive direction) perpendicular to the longitudinal direction of the discharge port 6. Thus, the coating material R inside the slit nozzle 30 is drawn from the discharge port 6 with the movement of the substrate W, and the coating material R is applied and spread over the entire surface of the substrate W.

As described above, the coating apparatus 1 brings the coating material R exposed from the discharge port 6 of the slit nozzle 30 into contact with the substrate W and horizontally moves the substrate W in this state, and thereby applies and spreads the coating material R over the substrate W so as to form a coating film.

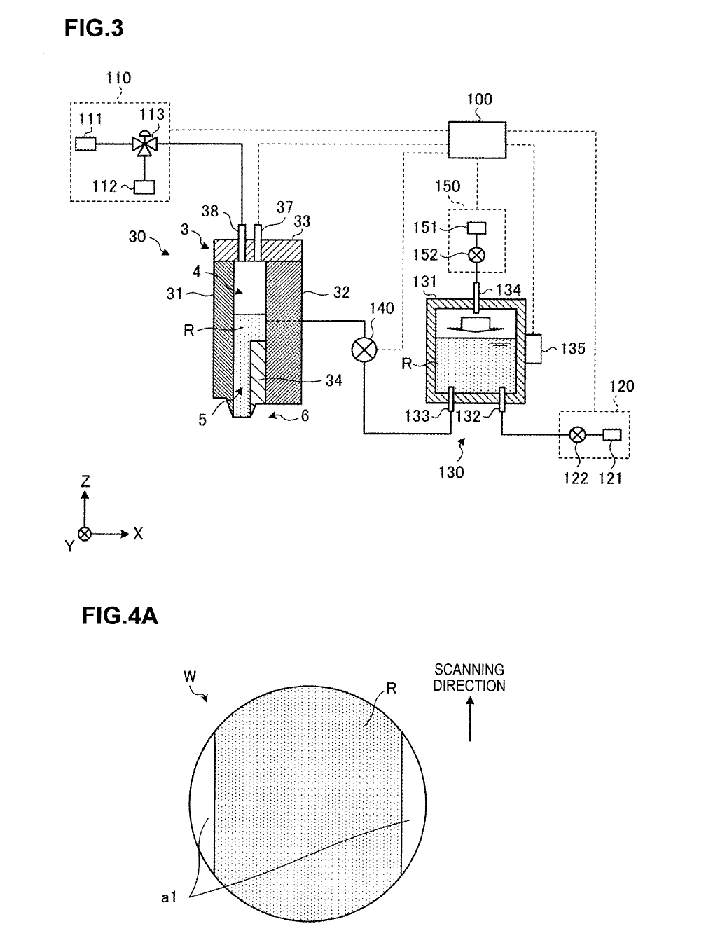

Next, the concrete configuration of the slit nozzle 30 will be described referring to FIG. 3. FIG. 3 is a schematic view illustrating the configuration of the slit nozzle 30.

As illustrated in FIG. 3, the slit nozzle 30 includes a main body part 3 in a long shape, a retention unit 4 that retains the coating material R inside the main body part 3, and the discharge port 6 in a slit shape that discharges the coating material R to be fed from the retention unit 4 via a flow path 5 in a slit shape.

The main body part 3 of the slit nozzle 30 includes a first wall part 31 forming a front surface portion, a second wall part 32 forming a back surface portion and both side surface portions of the slit nozzle 30, a lid part 33 forming a ceiling portion, and a land part 34 in a long shape disposed on a surface opposite to the first wall part 31 of the second wall part 32.

The first wall part 31, the second wall part 32, the lid part 33, and the land part 34 form an inner space of the slit nozzle 30. Of the inner space, a space which is formed by the first wall part 31 and the second wall part 32 is the retention unit 4, and a space which is formed by the first wall part 31 and the land part 34 and narrower than the retention unit 4 is the flow path 5. The width of the flow path 5 is constant, and the width of the discharge port 6 formed at the tip of the flow path 5 is the same as the flow path 5.

The width of the flow path 5 is set to a value so that the surface tension of the coating material R is smaller than the gravity acting on the coating material R in a state where the pressure inside the retention unit 4 is made equal to the pressure outside the retention unit 4 and the coating material R drips from the discharge port 6 at a predetermined flow rate. Specifically, the width of the flow path 5 is found in a test performed beforehand by changing the width of the flow path 5, the viscosity of the coating material R, and the material of the slit nozzle 30 and evaluating the state of the coating material R in that case.

In the lid part 33, a pressure measurement unit 37 that measures the pressure of an enclosed space surrounded by a liquid surface of the coating material R retained in the retention unit 4 and an internal wall surface of the retention unit 4, and a pressure regulation pipe 38 connected to a pressure regulation unit 110 that regulates the pressure inside the enclosed space, are provided penetrating the lid part 33. The pressure measurement unit 37 is electrically connected to the control apparatus 100 so that the measurement result is inputted to the control apparatus 100.

Note that the pressure measurement unit 37 may have any arrangement as long as it is communicated with the enclosed space inside the slit nozzle 30, and may be provided, for example, penetrating the first wall part 31.

The pressure regulation unit 110 has a configuration that an exhaust part 111 such as a vacuum pump and a gas supply source 112 that supplies gas such as an N2 are connected to the pressure regulation pipe 38 via a switching valve 113. The pressure regulation unit 110 is also electrically connected to the control apparatus 100, and adjusts the opening degree of the switching valve 113 by a command from the control apparatus 100 to connect either the exhaust part 111 or the gas supply source 112 to the pressure regulation pipe 38 so as to be able to regulate the exhaust rate from the inside of the retention unit 4 and regulate the amount of the gas to be supplied into the retention unit 4. Thus, the coating apparatus 1 can perform regulation so that the measurement result of the pressure measurement unit 37, namely, the pressure inside the retention unit 4 takes a predetermined value.

In this case, evacuating gas from the inside of the retention unit 4 makes the pressure inside the retention unit 4 lower than the pressure outside the retention unit 4 to thereby draw upward the coating material R inside the retention unit 4, thus making it possible to prevent the coating material R from dripping from the discharge port 6. Further, supplying gas into the retention unit 4 makes it possible to pressurize the coating material R remaining inside the retention unit 4 after application of the coating material R to push out or purge the coating material R.

Note that the configuration of the pressure regulation unit 110 is not limited to this embodiment, but may be arbitrarily set as long as it can control the pressure inside the retention unit 4. For example, the pressure regulation pipe 38 and a pressure regulation valve may be provided for each of the exhaust part 111 and the gas supply source 112 and individually connected to the lid part 33.

Further, as illustrated in FIG. 3, to the slit nozzle 30, a coating material supply system including a coating material supply unit 120, an intermediate tank 130, a supply pump 140, and a pressurization unit 150 is connected.

The coating material supply unit 120 includes a coating material supply source 121 and a valve 122. The coating material supply source 121 is connected to the intermediate tank 130 via the valve 122 and supplies the coating material R to the intermediate tank 130. Further, the coating material supply unit 120 is electrically connected to the control apparatus 100 so that opening and closing of the valve 122 is controlled by the control apparatus 100.

The intermediate tank 130 is a tank intervening between the coating material supply unit 120 and the slit nozzle 30. The intermediate tank 130 includes a tank unit 131, a first supply pipe 132, a second supply pipe 133, a third supply pipe 134, and a liquid level sensor 135.

The tank unit 131 retains the coating material R. At a bottom portion of the tank unit 131, the first supply pipe 132 and the second supply pipe 133 are provided. The first supply pipe 132 is connected to the coating material supply source 121 via the valve 122. Further, the second supply pipe 133 is connected to the slit nozzle 30 via the supply pump 140.

To the third supply pipe 134, the pressurization unit 150 is connected. The pressurization unit 150 includes a gas supply source 151 that supplies gas such as N2 and a valve 152, and pressurizes the inside of the tank unit 131 by supplying the gas into the tank unit 131. The pressurization unit 150 is electrically connected to the control apparatus 100 so that opening and closing of the valve 152 is controlled by the control apparatus 100.

The liquid level sensor 135 is a sensing unit that senses the liquid level of the coating material R retained in the tank unit 131. The liquid level sensor 135 is electrically connected the control apparatus 100 so that the sensing result is inputted into the control apparatus 100.

The supply pump 140 is provided at a middle of the second supply pipe 133 and supplies to the slit nozzle 30 the coating material R supplied thereto from the intermediate tank 130. The supply pump 140 is electrically connected the control apparatus 100 so that the supply rate of the coating material R to the slit nozzle 30 is controlled by the control apparatus 100.

The coating apparatus 1 operates the supply pump 140 to replenish the retention unit 4 of the slit nozzle 30 with the coating material R from the intermediate tank 130. In this event, the pressure inside the retention unit 4 is regulated to a negative pressure by the pressure regulation unit 110. Then, the coating apparatus 1 replenishes the retention unit 4 with the coating material R while gradually lowering the pressure (namely, increasing the degree of vacuum) inside the retention unit 4 that has been regulated to the negative pressure.

In the coating apparatus 1, sealing the discharge port 6 of the slit nozzle 30 with a not-illustrated sealing portion when replenishing the retention unit 4 of the slit nozzle 30 with the coating material R makes it possible to prevent the coating material R from leaking out of the discharge port 6 during replenishing processing.

Further, in the coating apparatus 1, the pressure regulation unit 110 is controlled to bring the inside of the retention unit 4 to a negative pressure, and supplies the coating material R to the inside of the retention unit 4 while gradually lowering the pressure inside the retention unit 4 that has been brought to the negative pressure, thereby more surely preventing the leakage of the coating material R.

In other words, when the liquid level of the coating material R rises due to supply of the coating material R to the retention unit 4, the hydraulic head pressure increases due to the coating material R acting on the discharge port 6. Assuming that the pressure inside the retention unit 4 and the pressure outside the retention unit 4 do not change but are constant during the supply, the force of pressing upward the coating material R relatively weakens by the increase in hydraulic head pressure, causing the possibility of the coating material R leaking out of the discharge port 6 sealed with the sealing portion.

In contrast, in the coating apparatus 1, the pressure regulation unit 110 gradually lowers the pressure inside the retention unit 4 in conjunction of the rise in liquid level height of the coating material R inside the retention unit 4, thereby making it possible to supplement the force of pressing upward the coating material R. Thus, it is possible to more surely prevent the coating material R from leaking out of the discharge port 6 sealed with the sealing portion during the processing of replenishing with the coating material R.

Note that the coating apparatus 1 may change the pressure inside the retention unit 4 according to predetermined time, or may change the pressure inside the retention unit 4 according to the detection result of a detection unit that is provided to detect the liquid level of the coating material R inside the retention unit 4.

Incidentally, in the case of trying to shorten the time of the coating treatment required for one substrate W, it is conceivable to increase a relative moving speed of the slit nozzle 30 with respect to the substrate W (hereinafter, described simply as a “moving speed of the slit nozzle 30”). However, if the moving speed of the slit nozzle 30 is simply increased, uncoated areas may occur on the substrate W to impair the film thickness uniformity.

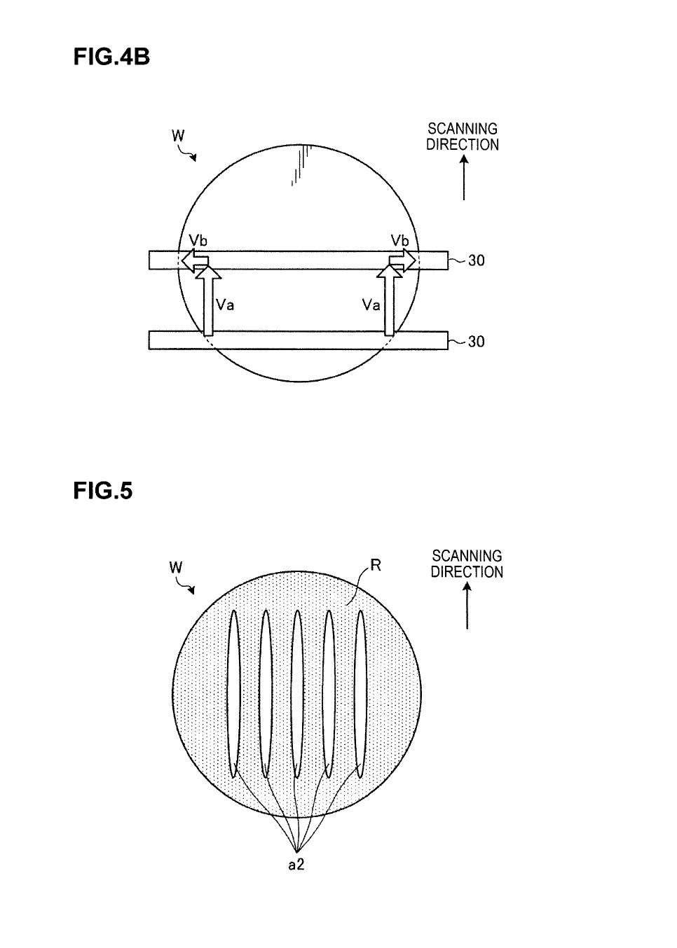

This point will be described referring to FIG. 4A, FIG. 4B, and FIG. 5. FIG. 4A and FIG. 4B are views for explaining an example of a situation in which the uncoated areas are formed on the substrate W. Further, FIG. 5 is a view for explaining another example of the situation in which the uncoated areas are formed on the substrate W.

Note that FIG. 4A and FIG. 5 each illustrate the appearance of a coating film formed on the substrate W in the case where the moving speed of the slit nozzle 30 is simply increased. “The case where the moving speed of the slit nozzle 30 is simply increased” referred to here is, for example, the case where the slit nozzle 30 is relatively moved with respect to the substrate W at a constant speed faster than the moving speed in the prior art. Further, the relative moving direction of the slit nozzle 30 with respect to the substrate W is described as a “scanning direction” hereinafter.

For example, when the moving speed of the slit nozzle 30 is simply increased, uncoated areas a1 where the coating material R is not applied may occur on both right and left sides of the substrate W in the scanning direction as illustrated in FIG. 4A.

This is because if the moving speed of the slit nozzle 30 is simply increased, a diffusion speed Vb of the coating material R in the width direction of the slit nozzle 30 cannot follow a moving speed Va of the slit nozzle 30 as illustrated in FIG. 4B.

Further, as illustrated in FIG. 5, if the moving speed of the slit nozzle 30 is too high, the coating material R may break to cause steak-like uncoated areas a2 along the scanning direction as illustrated in FIG. 5. Note that the steak-like uncoated areas a2 illustrated in FIG. 5 do not occur at a speed at which the uncoated areas a1 illustrated in FIG. 4A occur, but occur at a speed higher than the speed at which the uncoated areas a1 occur.

Hence, in the coating apparatus 1 according to this embodiment, the coating treatment is performed separately in three treatment steps of a “first constant speed coating treatment, an “acceleration coating treatment” and a “second constant speed coating treatment” described below in order to shorten the time required for the coating treatment without causing the uncoated areas a1, a2.

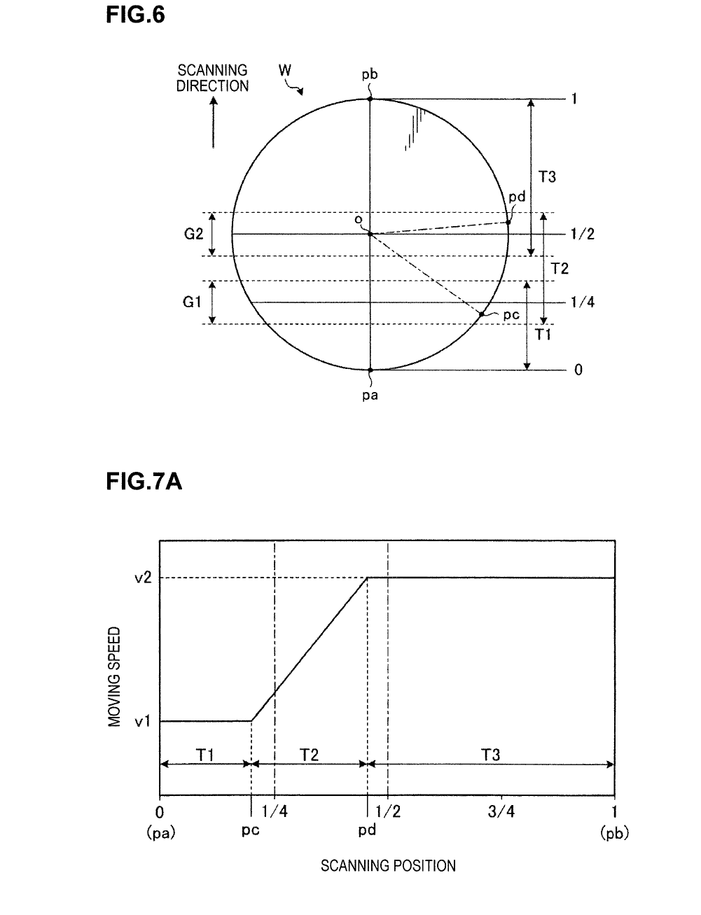

Hereinafter, concrete contents of the coating treatment performed by the coating apparatus 1 according to this embodiment will be described referring to FIG. 6. FIG. 6 is a view for explaining treatment sections of the first constant speed coating treatment, the acceleration coating treatment, and the second constant speed coating treatment.

As illustrated in FIG. 6, in the coating apparatus 1, the control unit 101 controls the first moving mechanism 22 to relatively move the slit nozzle 30 from a coating start position pa at one end portion of the substrate W to a coating end position pb at the other end portion of the substrate W.

The coating treatment performed in the coating apparatus 1 according to this embodiment has the three treatment steps such as the first constant speed coating treatment, the acceleration coating treatment, and the second constant speed coating treatment along the coating start position pa to the coating end position pb. Note that a first treatment section T1, a second treatment section T2, and a third treatment section T3 illustrated in FIG. 6 are treatment sections where the first constant speed coating treatment, the acceleration coating treatment, and the second constant speed coating treatment are performed respectively, and this point will be described later.

In the first constant speed coating treatment, the slit nozzle 30 is relatively moved with respect to the substrate W at a first speed v1. Subsequently, in the acceleration coating treatment, the moving speed of the slit nozzle 30 is accelerated to a second speed v2 higher than the first speed v1. Then, in the second constant speed coating treatment, the slit nozzle 30 is relatively moved with respect to the substrate W at the second speed v2.

The first speed v1 is a speed that does not cause the uncoated areas a1 illustrated in FIG. 4A nor the uncoated areas a2 illustrated in FIG. 5, and the second speed v2 is a speed that does not cause the uncoated areas a2. In other words, the uncoated areas a1 may occur if the slit nozzle 30 is relatively moved at a speed higher than the first speed v1, and the uncoated areas a2 may occur if the slit nozzle 30 is relatively moved at a speed higher than the second speed v2.

The uncoated areas a1 may occur when the diffusion speed Vb of the coating material R in the width direction of the slit nozzle 30 cannot follow the moving speed Va of the slit nozzle 30 as described above. A region of the substrate W in a disk shape where the coating material R should be diffused in the width direction of the slit nozzle 30 increases from the coating start position pa to the half of the substrate W, but its increasing rate gradually decreases as it goes closer to the position of the half of the substrate W. Then, when the slit nozzle 30 runs over the half of the substrate W, more specifically, a position away from the coating start position pa by a distance of ½ of the diameter of the substrate W, the region where the coating material R should be diffused in the width direction of the slit nozzle 30 turns to decrease. In other words, the uncoated areas a1 become less likely to occur as the slit nozzle 30 goes closer to the coating end position pb, and do not occur any longer after the slit nozzle 30 runs over the middle of the substrate W.

Hence, in the coating treatment according to this embodiment, first, the slit nozzle 30 is relatively moved at the first speed v1 at which the uncoated areas a1 do not occur (first constant speed coating treatment) and then accelerated from the first speed v1 to the second speed v2 at which the uncoated areas a2 do not occur (acceleration coating treatment), and the slit nozzle 30 is moved to the coating end position pb at the second speed v2. This makes it possible to shorten the time required for the coating treatment without causing the uncoated areas a1 nor the uncoated areas a2.

Further, as described above, the increasing rate of the region where the coating material R should be diffused in the width direction of the slit nozzle 30 gradually decreases as it goes closer to the position of the half of the substrate W. More specifically, when the slit nozzle 30 reaches the position away from the coating start position pa by a distance of ¼ of the diameter of the substrate W, the increasing rate of the region where the coating material R should be diffused in the width direction of the slit nozzle 30 becomes sufficiently small, so that even if the acceleration of the slit nozzle 30 is started at this position, the possibility that the uncoated areas a1 occur is low. However, the position from which the acceleration of the slit nozzle 30 can be actually started without causing the uncoated areas a1 differs depending on the viscosity of the coating material R, the coating pressure, the interval (nozzle gap) between the slit nozzle 30 and the substrate W, the diameter of the substrate W and so on.

Hence, in the coating treatment according to this embodiment, a first variation section G1 based on the position away from the coating start position pa by the distance of ¼ of the diameter of the substrate W is provided, and a predetermined position belonging to the first variation section G1 is set as a start point of the acceleration coating treatment (hereinafter, described as an “acceleration start position pc”).

Note that the first variation section G1 is a section where an angle formed between the coating start position pa and the acceleration start position pc using the center of the substrate W as an original point o is 45° to 75°.

Further, as described above, when the slit nozzle 30 runs over the position away from the coating start position pa by the distance of ½ of the diameter of the substrate W, the uncoated areas a1 never occur even if the moving speed of the slit nozzle 30 is increased up to the second speed v2. However, depending on the viscosity of the coating material R, the coating pressure, the nozzle gap, the diameter of the substrate W and so on, the uncoated areas a1 may not occur even if the moving speed of the slit nozzle 30 reaches the second speed v2 before the position away from the coating start position pa by the distance of ½ of the diameter of the substrate W.

On the other hand, if the moving speed of the slit nozzle 30 is rapidly increased in the acceleration coating treatment (namely, the acceleration of the slit nozzle 30 is too high), coating non-uniformity may occur. Therefore, the acceleration of the slit nozzle 30 is preferably set to a value at which the coating non-uniformity does not occur. From such circumstances, the time required for the acceleration coating treatment, namely, the time required to accelerate the slit nozzle 30 from the first speed v1 to the second speed v2 cannot be shorten by a certain time or more. Accordingly, even in the case where the uncoated areas a1 do not occur even if the moving speed of the slit nozzle 30 reaches the second speed v2 before the position away from the coating start position pa by the distance of ½ of the diameter of the substrate W, it cannot help but to set an end point of the acceleration coating treatment at a position closer to the coating end position pb side than is the position away from the coating start position pa by the distance of ½ of the diameter of the substrate W in some cases.

Hence, in the coating treatment according to this embodiment, a second variation section G2 based on the position away from the coating start position pa by the distance of ½ of the diameter of the substrate W is provided, and a predetermined position belonging to the second variation section G2 is set as an end point of the acceleration coating treatment (hereinafter, described as an “acceleration end position pd”).

Note that the second variation section G2 is a section where an angle formed between the coating start position pa and the acceleration end position pd using the center of the substrate W as the original point o is 75° to 105°.

As described above, the first constant speed coating treatment is performed from the coating start position pa as the start point to the acceleration start position pc belonging to the first variation section G1 as the end point, the acceleration coating treatment is performed from the acceleration start position pc as the start point to the acceleration end position pd belonging to the second variation section G2 as the end point, and the second constant speed coating treatment is performed from the acceleration end position pd as the start point to the coating end position pb as the end point. This makes it possible to appropriately shorten the time required for the coating treatment depending on the viscosity of the coating material R, the coating pressure, the nozzle gap, the diameter of the substrate W and so on.

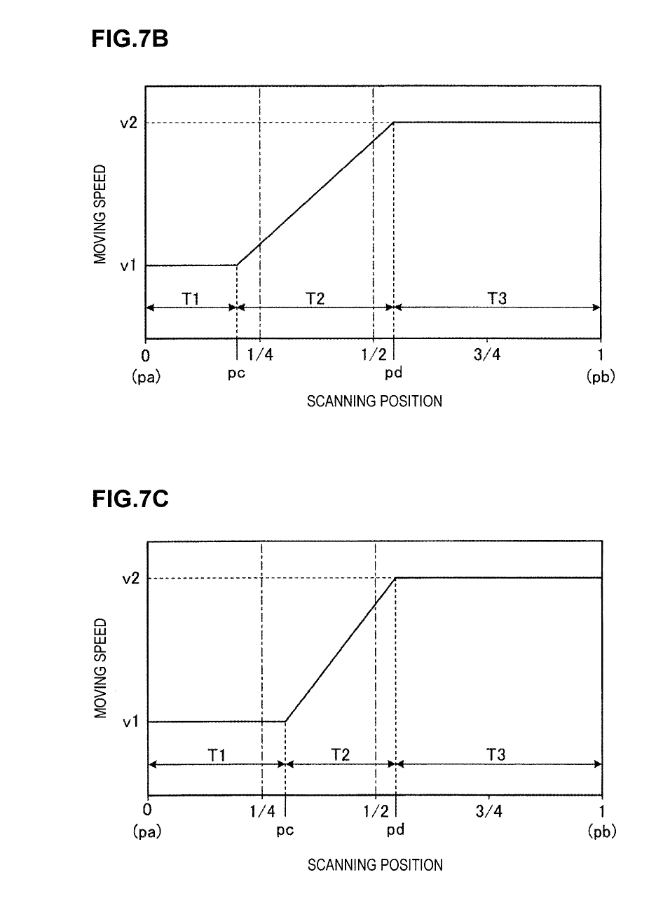

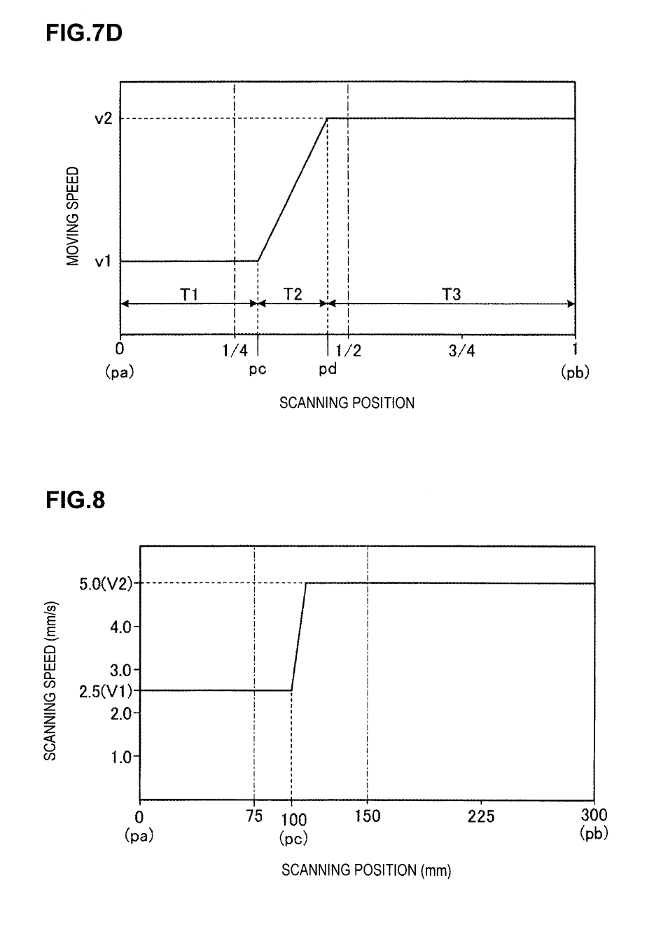

Next, concrete examples of the coating treatment will be described referring to FIG. 7A to FIG. 7D. FIG. 7A to FIG. 7D are charts for explaining examples of the coating treatment according to this embodiment. Note that FIG. 7A to FIG. 7D illustrate graphs indicating the position (scanning position) of the slit nozzle 30 above the substrate W on the horizontal axis and the moving speed of the slit nozzle 30 on the vertical axis.

For example, for the acceleration coating treatment in the example illustrated in FIG. 7A, the acceleration start position pc is set at a position before the position away from the coating start position pa by the distance of ¼ of the diameter of the substrate W, namely, closer to the coating start position pa, and the acceleration end position pd is set at a position closer to the coating end position pb than is the position away from the coating start position pa by the distance of ¼ of the diameter of the substrate W.

For example, if the viscosity of the coating material R is relatively low and the diffusion speed Vb (see FIG. 4B) in the width direction of the slit nozzle 30 is relatively high, the acceleration start position pc can be set at a position closer to the coating start position pa than is the position away from the coating start position pa by the distance of ¼ of the diameter of the substrate W as illustrated in FIG. 7A. This makes it possible for the moving speed of the slit nozzle 30 to early reach the second speed v2 so as to further shorten the time required for the coating treatment.

Further, in the example illustrated in FIG. 7A, if the increase in the acceleration of the slit nozzle 30 is restricted due to circumstances such as a low coating pressure, the acceleration end position pd can be set at a position closer to the coating end position pb than is the position away from the coating start position pa by the distance of ½ of the diameter of the substrate W as illustrated in FIG. 7B. This ensures the time for accelerating the moving speed of the slit nozzle 30 from the first speed v1 to the second speed v2 without causing coating non-uniformity.

Further, for example, if the viscosity of the coating material R is relatively high and the diffusion speed Vb (see FIG. 4B) in the width direction of the slit nozzle 30 is relatively low, the acceleration start position pc can be set at a position closer to the coating end position pb than is the position away from the coating start position pa by the distance of ¼ of the diameter of the substrate W as illustrated in FIG. 7C.

Further, if there is no possibility that the coating non-uniformity occurs even if the acceleration of the slit nozzle 30 is set to be high in the example illustrated in FIG. 7C, the acceleration end position pd can be set at a position closer to the coating start position pa than is the position away from the coating start position pa by the distance of ½ of the diameter of the substrate W as illustrated in FIG. 7D.

As has been described above, the coating apparatus 1 according to this embodiment includes the slit nozzle 30, the first moving mechanism 22, and the control unit 101. The slit nozzle 30 has the discharge port 60 in a slit shape and discharges the coating material R from the discharge port 6. The first moving mechanism 22 relatively moves the slit nozzle 30 with respect to the substrate W in a disk shape. The control unit 101 controls the first moving mechanism 22.

The control unit 101 controls the first moving mechanism 22 to perform the first constant speed coating treatment of relatively moving the slit nozzle 30 with respect to the substrate W at the first speed v1, the acceleration coating treatment of accelerating, after the first constant speed coating treatment, the relative moving speed of the slit nozzle 30 with respect to the substrate W to the second speed v2 higher than the first speed v1, and the second constant speed coating treatment of relatively moving, after the acceleration coating treatment, the slit nozzle 30 with respect to the substrate W at the second speed v2. Therefore, the coating apparatus 1 according to this embodiment can shorten the time required for the coating treatment while ensuring the film thickness uniformity.

(Evaluation Result of Coating Apparatus)

An evaluation test of the coating apparatus 1 according to this embodiment was performed, and therefore the evaluation result will be described here referring to FIG. 8. FIG. 8 is a chart illustrating the evaluation result of the coating apparatus 1 according to this embodiment. In this evaluation test, a substrate W with a diameter of 300 mm was used and the film thickness of the coating film was set to 10 μm.

As illustrated in FIG. 8, in this evaluation test, the slit nozzle 30 was moved first in a section from a scanning position of 0 mm (coating start position pa) to a scanning position of 100 mm (acceleration start position pc), at a constant speed of a first speed v1=2.5 mm/s (first constant speed coating treatment). Subsequently, the moving speed was increased at an acceleration of 1 mm/s2 up to a second speed v2=5.0 mm/s (acceleration coating treatment), and then the slit nozzle 30 was moved to a scanning position of 300 mm (coating end position pb) at a constant speed of the second speed v2=5.0 mm/s (second constant speed coating treatment). As a result of this, the coating film could be formed on the substrate W without causing the uncoated areas a1, a2.

Note that the first speed v1 and the second speed v2 can be appropriately changed according to the viscosity of the coating material, the film thickness and so on. More specifically, the first speed v1 can be changed in a range of 1 to 3 mm/s, and the second speed v2 can be changed in a range of 5 to 10 mm/s. Further, the acceleration of the slit nozzle 30 in the acceleration coating treatment is preferably about 1 mm/s2 as described above.

### Other Embodiments

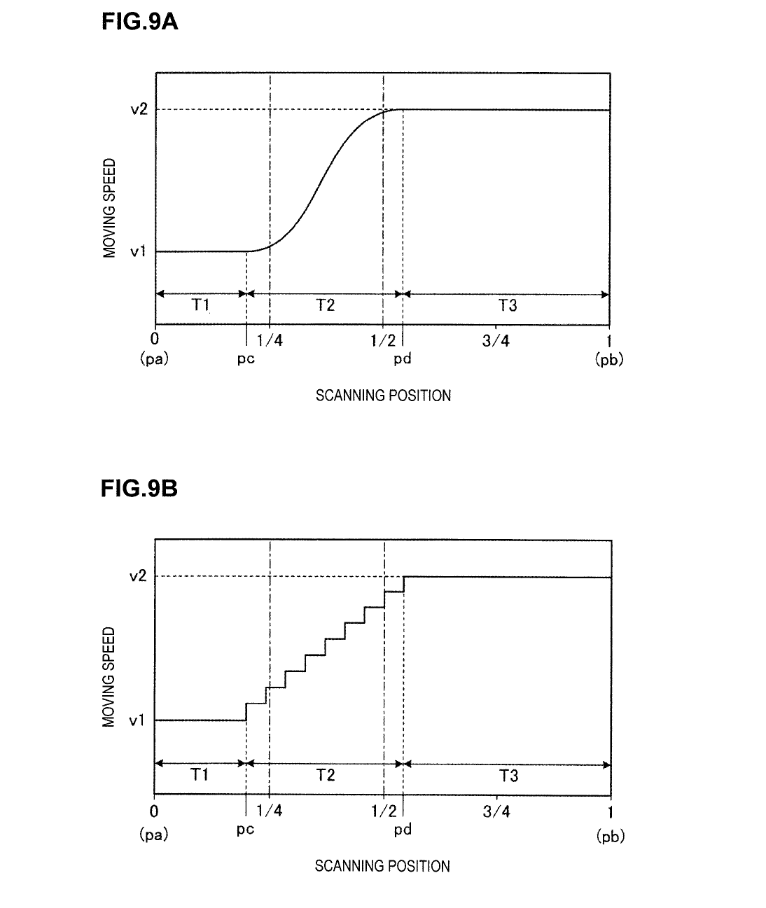

Next, modification examples of the coating treatment performed by the coating apparatus 1 according to this embodiment will be described referring to FIG. 9A and FIG. 9B. FIG. 9A and FIG. 9B are charts for explaining examples of the coating treatment according to the modification examples of this embodiment. Note that, in the following description, the same reference numerals as those of the already described components are given to the same components as the already described components to omit repeated description.

Though the slit nozzle 30 is linearly accelerated from the first speed v1 to the second speed v2 (see FIG. 7A to FIG. 7D) in the acceleration coating treatment in the above-described embodiment, the moving speed of the slit nozzle 30 may be increased in a curve in conformity with the shape of the substrate W, for example, as illustrated in FIG. 9A. In particular, changing the moving speed of the slit nozzle 30, for example, in a manner of a sigmoid function so that the speed change becomes smooth at the acceleration start position pc and the acceleration end position pd, makes it possible to suppress occurrence of the coating non-uniformity at the acceleration start position pc and the acceleration end position pd. Further, the moving speed of the slit nozzle 30 may be changed stepwise as illustrated in FIG. 9B.

Further, though the example in the case of performing the first constant speed coating treatment, the acceleration coating treatment, and the second constant speed coating treatment has been described in the above-described embodiment, the coating apparatus 1 may further perform, after the second constant speed coating treatment, a second acceleration coating treatment of accelerating the slit nozzle 30 to a third speed. Further, the coating apparatus 1 may perform, after the second acceleration coating treatment, a third constant speed coating treatment of relatively moving the slit nozzle 30 with respect to the substrate W at the third speed.

Further effects and modifications can be easily derived by hose skilled in the art. Therefore, wide-ranging aspects of the present invention are not limited by the specific details and the representative embodiment expressed and described as above. Accordingly, it is possible to make various changes and modifications without departing from the spirit and scope of the comprehensive concept of the invention defined by the accompanying claims and equivalents thereof.

What is claimed is:

1. A coating apparatus for applying a coating material to a substrate, comprising:
a slit nozzle that has a discharge port in a slit shape and discharges the coating material from the discharge port;
a moving mechanism that relatively moves the slit nozzle with respect to a substrate in a disk shape; and
a control unit that controls the moving mechanism,
wherein the control unit is configured to control the moving mechanism to thereby perform a first constant speed coating treatment of relatively moving the slit nozzle with respect to the substrate at a first speed, an acceleration coating treatment of accelerating, after the first constant speed coating treatment, a relative moving speed of the slit nozzle with respect to the substrate to a second speed higher than the first speed, and a second constant speed coating treatment of relatively moving, after the acceleration coating treatment, the slit nozzle with respect to the substrate at the second speed.
